(19) United States
(12) Patent Application Publication
(10) Pub. No.: US 2018/0136965 A1
(43) Pub. Date: May 17, 2018

(54) Additional Cost and Schedule Change Prediction Due to Communication Errors

(71) Applicant: International Business Machines Corporation, Armonk, NY (US)

(72) Inventors: Yasuko Andoh, Tokyo (JP); Kazuro Haga, Tokyo (JP); Katsuroh Hayashi, Kanagawa (JP); Nozomu Matsushita, Tokyo (JP)

(21) Appl. No.: 15/354,003

(22) Filed: Nov. 17, 2016

(51) Int. Cl. G06F 9/46; G06F 9/50

(52) U.S. Cl. CPC G06F 9/466; G06F 9/5005

(57) ABSTRACT

A mechanism is provided for predicting a rework rate due to the communication error in a transfer task. A rework rate value and feedback analysis is determined based on a soundness of a communication provided by a first entity in the transfer task. The rework rate value and the feedback analysis is sent to a project manager, where, using the rework rate value and the feedback analysis, the project manager provides an indication. The transfer task is sent back to the first entity indicating that more information is required for the transfer task in response to receiving an indication to redirect the transfer task back to the first entity to re-perform the transfer task. The second entity is enabled to commence with the subsequent task in response to receiving an indication to enable the second entity to commence with the subsequent task.

### BACKGROUND

The present application relates generally to an improved data processing apparatus and method and more specifically to mechanisms for predicting the additional costs and schedule changes due to communication errors.

In multi-user project environments, knowledge is passed between different users when these users collaborate to complete tasks within a given project. Tasks within a given project may include creating documents, implementing software, testing software, configuring resources, or the like, which are all assigned to reach a common objective. However, when the actual time to complete a task differs from the estimated time, the cause for the difference is analyzed and the remaining work time is re-estimated.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for predicting a rework rate due to the communication error in a transfer task. Responsive to receiving an indication that the transfer task is being created, the transfer task indicating a transfer of responsibility of a project from a first entity to a second entity, the illustrative embodiment determines a rework rate value and feedback analysis based on a soundness of a communication provided by the first entity in the transfer task. The illustrative embodiment sends the rework rate value and the feedback analysis to a project manager. In the illustrative embodiment, using the rework rate value and the feedback analysis, the project manager provides either an indication to redirect the transfer task back to the first entity to re-perform the transfer task or an indication to enable the second entity to commence with a subsequent task. Responsive to receiving the indication to redirect the transfer task back to the first entity to re-perform the transfer task, the illustrative embodiment sends the transfer task back to the first entity indicating that more information is required for the transfer task. Responsive to receiving the indication to enable the second entity to commence with the subsequent task, the illustrative embodiment enables the second entity to commence with the subsequent task.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a cloud computing node according to an illustrative embodiment;

FIG. 2 depicts a cloud computing environment according an illustrative embodiment;

FIG. 3 depicts abstraction model layers according to an illustrative embodiment;

FIG. 4 depicts a functional block diagram of the operation performed by a cost and schedule prediction mechanism in accordance with an illustrative embodiment.

FIG. 5 depicts a flowchart of the operation performed by an efficacy evaluation mechanism in evaluating the adequacy of an information in a transfer task in accordance with an illustrative embodiment; and

FIG. 6 depicts a flowchart of the operation performed by a cost and schedule prediction mechanism in predicting a rework rate due to the communication error based on a determination value of a soundness of the communication that caused the error in accordance with an illustrative embodiment.

### DETAILED DESCRIPTION

The illustrative embodiments provide for predicting the additional costs and schedule changes due to communication errors. As noted previously, when the actual time to complete a task differs from the estimated time, the cause for the difference is analyzed and the remaining work time is re-estimated. Currently, in the prediction of the completion time, the cause is analyzed for each task or process, such as estimation, specification, design, test, or the like, and, if the same error is likely to occur again, the remaining work time is often modified. However, even when the analysis of the cause reveals that the cause is a communication error, current solutions fail to reflect the influence of the communication error on the remaining work time, because the rework time due to the communication error is unclear.

The illustrative embodiments provide a cost and schedule prediction mechanism for predicting a rework rate due to the communication error based on a determination value of a soundness of the communication that caused the error. Utilizing the soundness of communication value, the cost and schedule prediction mechanism calculates additional man-hours and schedule changes that are required for subsequent tasks. The cost and schedule prediction mechanism improves the prediction of the rework rate by the repetition of feedback, allowing the enhancement of the accuracy of the calculation. Furthermore, the cost and schedule prediction mechanism simulates the cost and schedule changes for subsequent task(s) and the cost and schedule changes for re-performing a transfer task, thereby providing additional information to support project manager(s) in making further determinations.

Before beginning the discussion of the various aspects of the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a,” “at least one of,” and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

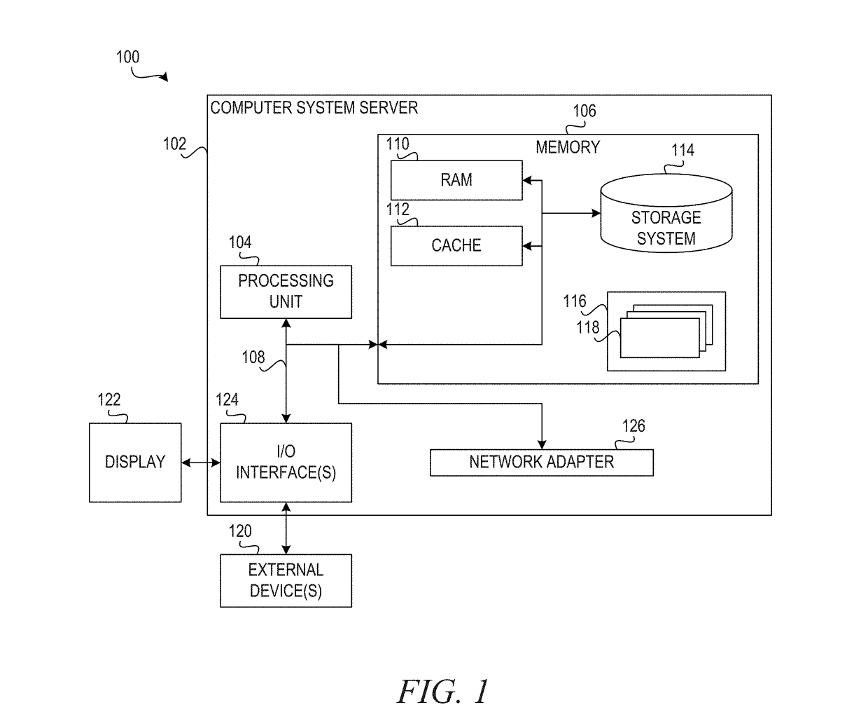

Referring now to FIG. 1, a schematic of an example of a cloud computing node is shown. Cloud computing node 100 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 100 there is a computer system/server 102, which is operational with numerous other general purpose or special purpose computing system environments or configurations. Examples of well-known computing systems, environments, and/or configurations that may be suitable for use with computer system/server 102 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 102 may be described in the general context of computer system executable instructions, such as program modules, being executed by a computer system. Generally, program modules may include routines, programs, objects, components, logic, data structures, and so on that perform particular tasks or implement particular abstract data types. Computer system/server 102 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 102 in cloud computing node 100 is shown in the form of a general-purpose computing device. The components of computer system/server 102 may include, but are not limited to, one or more processors or processing units 104, a system memory 106, and a bus 108 that couples various system components including system memory 106 to processor 104.

Bus 108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 102 typically includes a variety of computer system readable media. Such media may be any available media that is accessible by computer system/server 102, and it includes both volatile and non-volatile media, removable and non-removable media.

System memory 106 can include computer system readable media in the form of volatile memory, such as random access memory (RAM) 110 and/or cache memory 112. Computer system/server 102 may further include other removable/non-removable, volatile/non-volatile computer system storage media. By way of example only, storage system 114 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 108 by one or more data media interfaces. As will be further depicted and described below, memory 106 may include at least one program product having a set (e.g., at least one) of program modules that are configured to carry out the functions of embodiments of the invention.

Program/utility 116, having a set (at least one) of program modules 118, may be stored in memory 106 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 102 may also communicate with one or more external devices 120 such as a keyboard, a pointing device, a display 122, etc.; one or more devices that enable a user to interact with computer system/server 102; and/or any devices (e.g., network card, modem, etc.) that enable computer system/server 102 to communicate with one or more other computing devices. Such communication can occur via Input/Output (I/O) interfaces 124. Still yet, computer system/server 102 can communicate with one or more networks such as a local area network (LAN), a general wide area network (WAN), and/or a public network (e.g., the Internet) via network adapter 126. As depicted, network adapter 126 communicates with the other components of computer system/server 102 via bus 108. It should be understood that although not shown, other hardware and/or software components could be used in conjunction with computer system/server 102. Examples, include, but are not limited to: microcode, device drivers, redundant processing units, external disk drive arrays, RAID systems, tape drives, and data archival storage systems, etc.

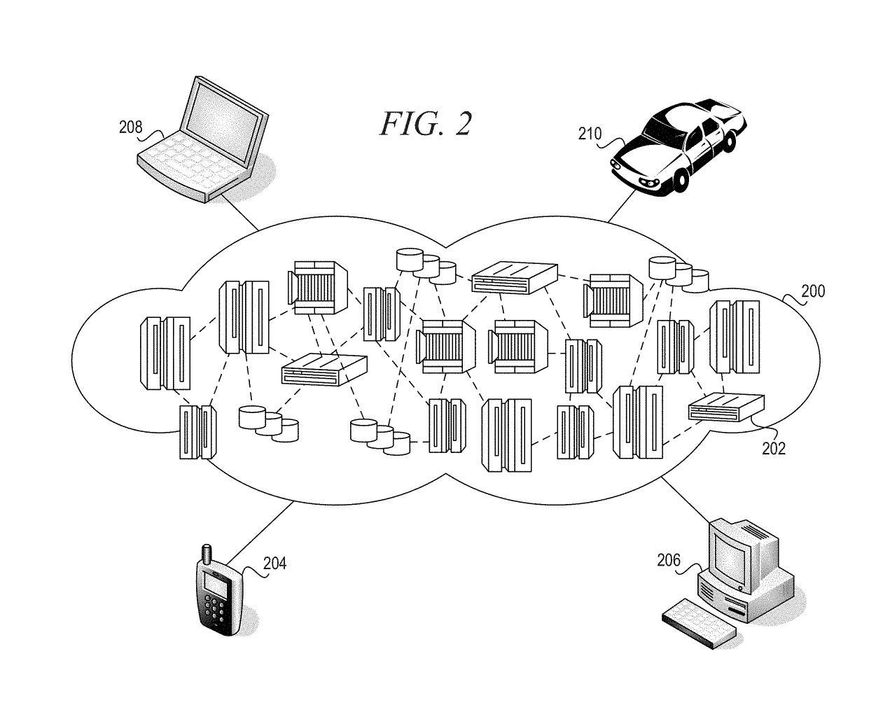

Referring now to FIG. 2, illustrative cloud computing environment 200 is depicted. As shown, cloud computing environment 200 comprises one or more cloud computing nodes 202, such as cloud computing node 100 of FIG. 1, with which local computing devices used by cloud consumers, such as, for example, personal digital assistant (PDA) or cellular telephone 204, desktop computer 206, laptop computer 208, and/or automobile computer system 210 may communicate. Nodes 202 may communicate with one another. They may be grouped (not shown) physically or virtually, in one or more networks, such as Private, Community, Public, or Hybrid clouds as described hereinabove, or a combination thereof. This allows cloud computing environment 200 to offer infrastructure, platforms and/or software as services for which a cloud consumer does not need to maintain resources on a local computing device. It is understood that the types of computing devices 204-210 shown in FIG. 2 are intended to be illustrative only and that computing nodes 202 and cloud computing environment 200 can communicate with any type of computerized device over any type of network and/or network addressable connection (e.g., using a web browser).

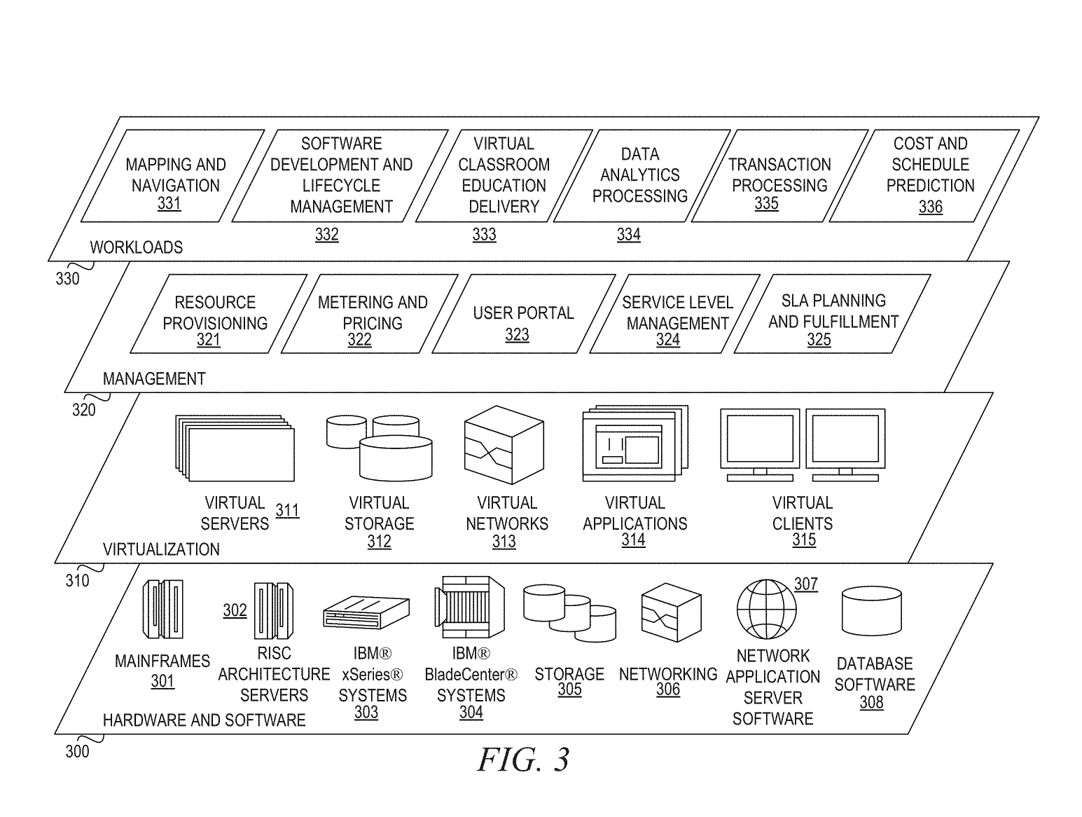

Referring now to FIG. 3, a set of functional abstraction layers provided by a cloud computing environment, such as cloud computing environment 200 of FIG. 2, is shown. It should be understood in advance that the components, layers, and functions shown in FIG. 3 are intended to be illustrative only and embodiments of the invention are not limited thereto. As depicted, the following layers and corresponding functions are provided:

Hardware and software layer 300 includes hardware and software components. Examples of hardware components include: mainframes 301; RISC (Reduced Instruction Set Computer) architecture based servers 302; servers 303; blade servers 304; storage devices 305; and networks and networking components 306. In some embodiments, software components include network application server software 307 and database software 308.

Virtualization layer 310 provides an abstraction layer from which the following examples of virtual entities may be provided: virtual servers 311; virtual storage 312; virtual networks 313, including virtual private networks; virtual applications and operating systems 314; and virtual clients 315.

In one example, management layer 320 may provide the functions described below. Resource provisioning 321 provides dynamic procurement of computing resources and other resources that are utilized to perform tasks within the cloud computing environment. Metering and Pricing 322 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 323 provides access to the cloud computing environment for consumers and system administrators. Service level management 324 provides cloud computing resource allocation and management such that required service levels are met. Service Level Agreement (SLA) planning and fulfillment 325 provide pre-arrangement for, and procurement of, cloud computing resources for which a future requirement is anticipated in accordance with an SLA.

Workloads layer 330 provides examples of functionality for which the cloud computing environment may be utilized. Examples of workloads and functions which may be provided from this layer include: mapping and navigation 331; software development and lifecycle management 332; virtual classroom education delivery 333; data analytics processing 334; transaction processing 335; and cost and schedule prediction mechanism 336, as described herein. Cost and schedule prediction mechanism 336 may be understood with regard to the following Figures.

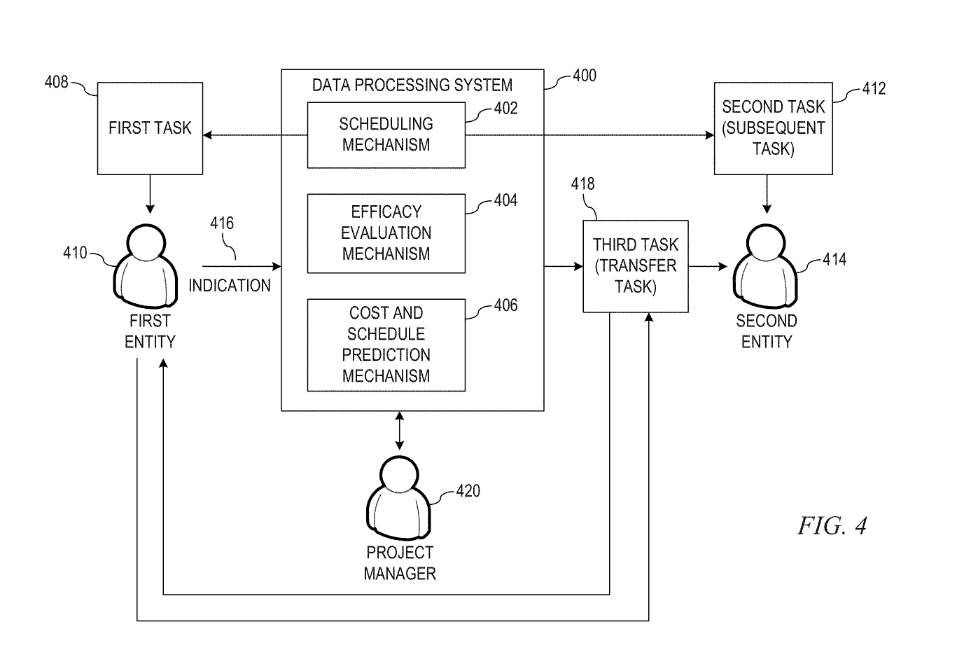

FIG. 4 depicts a functional block diagram of the operation performed by a cost and schedule prediction mechanism in accordance with an illustrative embodiment. Data processing system 400, which is a data processing system, such as cloud computing node 100 of FIG. 1, comprises scheduling mechanism 402, efficacy evaluation mechanism 404, and cost and schedule prediction mechanism 406. In operation, scheduling mechanism assigns one or more tasks to one or more entities, such as assigning a first task 408 to first entity 410 and second task 412 to second entity 414. Efficacy evaluation mechanism 404 receives an indication 416 from the first entity 410 that the first task 408 assigned to the first entity 410 is complete. In response to receiving the indication 416, efficacy evaluation mechanism 404 generates a third task 418. The third task 418 may be understood as a transfer task, in that the third task 418 includes data to be communicated by the first entity 410 to the second entity 414 related to transferring responsibility for the project (or process) from the first entity 410 to the second entity 414, before the second entity commences the second task 412. In an example where a first task precedes a second task, when the tasks are assigned to different entities, the shift of a task from one entity to another may be tracked as a transfer, rather than another task. Thus, for clarity, by efficacy evaluation mechanism 404 generating the third task 418, the order of the tasks in the project or process becomes: the first task 408, the third task 418 (the transfer task), and then, the second task 412.

As part of generating the third task 418, efficacy evaluation mechanism 404 identifies data to be communicated from the first entity 410 to the second entity 414, before the second entity 414 commences with the second task 412. That is, the third task 418 may be understood as a transfer plan and may include the type of information that the first entity 410 should communicate to the second entity 414 before the second entity 414 commences the second task 412 (the subsequent task), the content of the communication, the timing of the communication, the method of communication, or the like.

In one embodiment, efficacy evaluation mechanism 404 assigns the third task 418 (the intermittent task between the first task 408 and the second task 412) to the first entity 410 before assigning the third task 418 to the second entity 414. Data required by efficacy evaluation mechanism 404 may vary in accordance with the type of tasks that comprise the project. For example, in one embodiment where the first task 408 precedes the second task 412, efficacy evaluation mechanism 404 requires the first entity 410 to communicate information to the second entity 414 that will enable that the second entity 414 to effectively and efficiently complete the second task 412. Thus, efficacy evaluation mechanism 404 may require the first entity 410 to provide data related to certain attributes. An example of the attributes may include:
Who: from designer A to developer B;
What: the content of the approved design document;
Where: in the project room;
When: before development operation is started; and
How: to be explained face to face three times.

Thus, in one non-limiting example, the data (also referred to herein as a communication) is categorized into who, what, where, when, and how attributes. Taken together, the attributes describe a communication plan that is part of the third task 418. This communication plan describes the data that the first entity 410 should communicate to the second entity 414 so that the efficiency of the project may be maintained despite the switch in which entity is to complete the next task.

Efficacy evaluation mechanism 404 receives an indication that the first entity 410 has provided information for the third task 418 and determines whether the first entity 410 has communicated an adequate amount of information to exceed the predetermined threshold of the communication plan so that the second entity 414 may complete the second task 412. Upon receiving the indication that the first entity 410 has provided information for the third task 418, efficacy evaluation mechanism 404 compares the information provided by the first entity 410 in the third task 418 to the communication plan and determines whether the information provided by the first entity 410 is above a predetermined threshold of the communication plan for the second entity 414 to proceed with the second task 412. In an embodiment of the present invention, efficacy evaluation mechanism 404 makes this determination based on records of the communications between the first entity 410 and the second entity 414 that efficacy evaluation mechanism 404 from a memory, such as from system memory 106 of FIG. 1.

Table 1 includes examples of electronically obtained and stored information that efficacy evaluation mechanism 404 may utilize when evaluating the communications between the first entity 410 and the second entity 414 to determine whether the data provided by the first entity 410 is above a predetermined threshold of the communication plan, i.e. was enough data of the communication plan actually communicated between by the first entity 410 in the third task 418.

TABLE 1

| Data Attribute | Data Source |
|---|---|
| Who | Conference room reservation information, and position |
| | information of individuals (e.g., obtained via GPS, CAS, |
| | IP address, etc.) in the case of a meeting. |
| | A sender and a recipient in an e-mail, telephone call, |
| | and/or electronic chat. |
| What | Minutes information and voice conversation audio |
| | information (e.g., obtained via text mining). |
| | Logs of projectors and printers utilized in a meeting. |
| | Attached file to e-mail, email telephone call, and/or |
| | electronic chat (e.g., obtained via text mining). |
| Where | Conference room reservation information and position |
| | information (e.g., obtained via GPS, CAS, IP address, |
| | etc.). |
| When | Conference room reservation information, meeting |
| | minutes information, voice conversation audio |
| | information (e.g., obtained via text mining) related to the |
| | meeting. |
| | Information on the transmission date and time in the case |
| | of e-mail, telephone call, and and/or electronic chat. |
| How | History log information on the meeting, e-mail, |
| | telephone call, and chatting. |

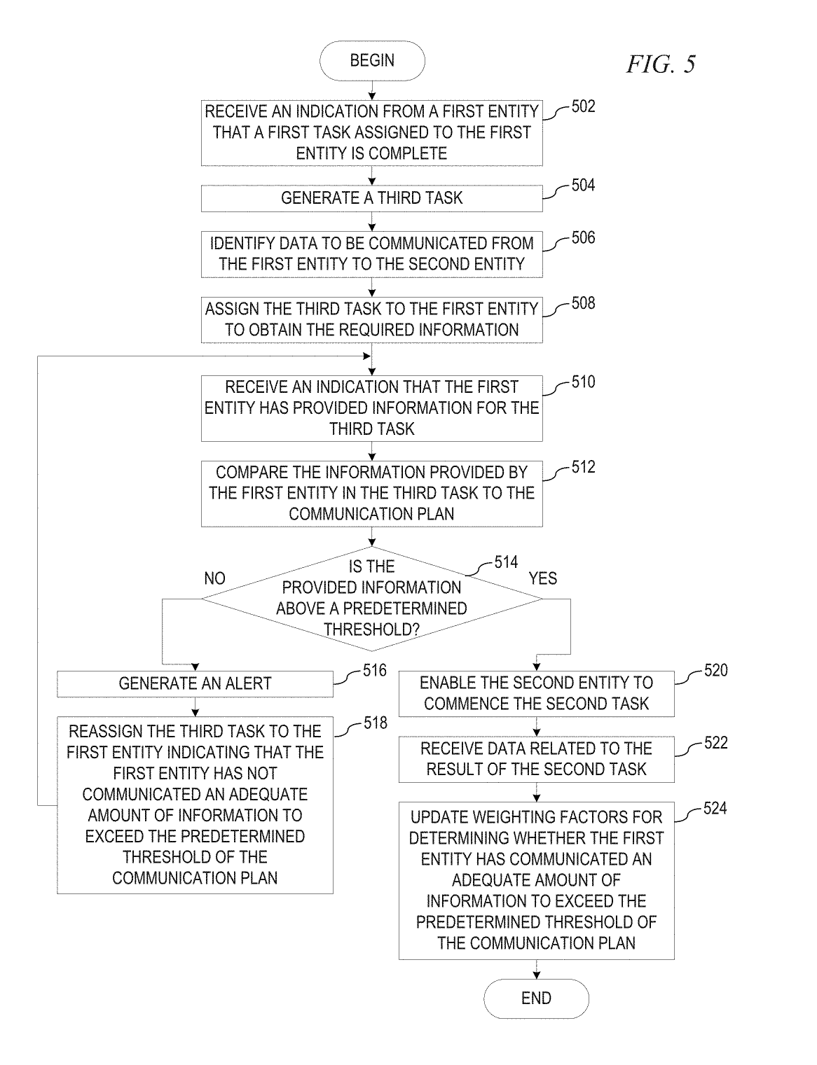

One advantage of the illustrative embodiment is that efficacy evaluation mechanism 404 generating and evaluating a transfer task (e.g., the third task 418) after the first entity 410 providing the data enables efficacy evaluation mechanism 404 to identify issues with the communications in the transfer task that could negatively impact the project as a whole and therefore, the efficiency and/or efficacy of the computing system. For example, as will be discussed in detail, FIG. 5 illustrates efficacy evaluation mechanism 404 identifying data related to the result of the second task 412 and utilizes the data to update determination logic. Below are some examples of issues that may be identified by efficacy evaluation mechanism 404 when determining whether the first entity 410 has communicated an adequate amount of information to exceed the predetermined threshold of the communication plan to the second entity 414.

In one example, efficacy evaluation mechanism 404 generates a third task specifying that that entity A should make explanations to entity B in three meetings (e.g., utilizing who and when attributes), but when efficacy evaluation mechanism 404 receives an indication that the first entity has provided the information for the third task, efficacy evaluation mechanism 404 identifies that the information indicates that only a single meeting was held between entity A and entity B from the commencement of the transfer task through its completion.

In another example, efficacy evaluation mechanism 404 generated a third task specifying that entity A should make explanation to the entity B during a face to face meeting (e.g., utilizing the who, how and where attributes), but when efficacy evaluation mechanism 404 receives an indication that the first entity has provided the information for the third task, efficacy evaluation mechanism 404 identifies that the information indicates that the only communication between entity A and entity B during the third task is one e-mail from the entity A to the entity B. In addition, efficacy evaluation mechanism 404 determines that there is no record of a question being sent from entity B to the entity A and/or no confirmation was sent in reply from entity B to entity A.

In another example, efficacy evaluation mechanism 404 generates a third task specifying that entity A should explain the content of an approved design document to the entity B in a meeting (e.g., utilizing the who and what attributes), but efficacy evaluation mechanism 404 determines based on text mining that entity A explained the design document draft instead.

In part, by efficacy evaluation mechanism 404 identifying the differences between the information provided by the first entity and the information that was to be provided by the first entity, efficacy evaluation mechanism 404 determines whether the first entity 410 has communicated an adequate amount of information to exceed the predetermined threshold of the communication plan to the second entity 414. In an illustrative embodiment, the adequate amount of information to exceed the predetermined threshold of the communication plan is a point that is sufficiently close to the data the efficacy evaluation mechanism 404 specified in generating the third task 418 such that the efficiency and/or efficacy of the project and the system is not compromised, or is only compromised within an acceptable tolerance when the second entity 414 commences the second task 412 in response to the completion of the third task 418. Efficacy evaluation mechanism 404 determines whether the first entity 410 has communicated an adequate amount of information to exceed the predetermined threshold of the communication plan to the second entity 414 by assigning a weighted value to each of the data attributes included in the third task 418. That is, for each of the attributes (e.g., who, what, where, when, and how), efficacy evaluation mechanism 404 may assign a percentage tolerance for differences as a threshold. For ease of understanding, in one non-limiting example, for each of the attributes of who, what, when, where, and how, efficacy evaluation mechanism 404 may set 20% of the difference between the data in the task generated by efficacy evaluation mechanism 404 and the data obtained by efficacy evaluation mechanism 404 at the conclusion of the third task 418 by the first entity 410 as a threshold. In this example, the weighting factors for the five attributes are each defined as 20% (100% in total).

As aforementioned, in an illustrative embodiment, the data identified by efficacy evaluation mechanism 404 to be communicated from the first entity 410 to the second entity 414 during the third task is compared to data obtained by efficacy evaluation mechanism 404 in response to completion of the third task 418 by the first entity 418. Based upon the comparison, including weighted values assigned to various data attributes, efficacy evaluation mechanism 404 determines whether the first entity 410 has communicated an adequate amount of information to exceed the predetermined threshold of the communication plan and thus, whether to generate an alert or enable the second entity 414 to process or project to move forward to the next task, in this case, the second task 412. Equation 1 below is one example of a comparison that efficacy evaluation mechanism 404 may use to make this determination.

$$\sum \frac{data identified - data communcated}{data identified} \times weighting factors \qquad ( Equation 1 )$$

Tables 2 and 3 below demonstrate how efficacy evaluation mechanism 404 utilizes Equation 1, as one example, to determine whether the first entity 410 has communicated an adequate amount of information to exceed the predetermined threshold of the communication plan to the second entity 414. Utilizing Equation 1, assume that efficacy evaluation mechanism 404 weights each of five data attributes (e.g., who, what, where, when, and how) at 20%, and, as represented in Table 2, the data identified differs from the data communicated as related to the what and how attributes. In the example below, efficacy evaluation mechanism 404 assigned values to the data identified and the data communicated by converting a keyword matched into numerical values between the data identified and the data communicated, which may also be understood as the data obtained related to the communications between the first entity 410 and the second entity 414 during the transfer task, i.e. the third task 418. As another example, if the planned recipients defined by the who attribute were B and C, but the actual recipient was B only, then efficacy evaluation mechanism 404 would set the value of the data identified to 2.0 and the actual value to 1.0.

TABLE 2

| Data | Value of Data | Value of Data |
|---|---|---|
| Attribute | Identified | Communicated |
| What | 2.0 | 1.0 |
| How | 3.0 | 1.0 |

Taking into account the values of Table 2 and Equation 1, Table 3 is an example of how, in another example, efficacy evaluation mechanism 404 determines whether the first entity 410 has communicated an adequate amount of information to exceed the predetermined threshold of the communication plan to the second entity 414.

TABLE 3

| Data | Value of Data | Value of Data | Weighting | |
|---|---|---|---|---|
| Attribute | Identified | Communicated | Factor | Result |
| Who | 1.0 | 1.0 | 0.2 | 0 |
| What | 2.0 | 1.0 | 0.2 | 0.1 |
| Where | 1.0 | 1.0 | 0.2 | 0 |
| When | 1.0 | 1.0 | 0.2 | 0 |
| How | 3.0 | 1.0 | 0.2 | 0.13 |
| Total | | | | 0.23 |

In the example above, assuming that efficacy evaluation mechanism 404 determines that a first entity 410 has communicated an adequate amount of information to exceed the predetermined threshold of the communication plan to the second entity 414 if the total (e.g., the obtained determination) is greater than 0.225, because 0.23 is greater than 0.225, in this example, efficacy evaluation mechanism 404 would generate an alert.

That is, in response to efficacy evaluation mechanism 404 determining that the first entity 410 did not communicate an adequate amount of information to exceed the predetermined threshold of the communication plan, efficacy evaluation mechanism 404 would generates an alert. After efficacy evaluation mechanism 404 generates an alert, efficacy evaluation mechanism 404 may initiate the third task 418 again (i.e. reassign the task to the first entity) rather than enabling the second entity 414 to commence the second task 412. In a further embodiment, in response to efficacy evaluation mechanism 404 determining that the first entity 410 has not communicated an adequate amount of information to exceed the predetermined threshold of the communication plan to the second entity 414, efficacy evaluation mechanism 404 changes the status of the third task 418 (the transfer task) to “pending.” Still further, in response to efficacy evaluation mechanism 404 determining that the first entity 410 has not communicated an adequate amount of information to exceed the predetermined threshold of the communication plan to the second entity 414, efficacy evaluation mechanism 404 notifies at least one user with a message, for example, “a problem has been found in the communication.”

In response to determining that the first entity 410 has communicated an adequate amount of information to exceed the predetermined threshold of the communication plan, efficacy evaluation mechanism 404 enables the second entity 414 to commence the second task 412. In response to the second entity 414 completing the second task 412, efficacy evaluation mechanism 404 receives data related to the result of the second task 412 and utilizes the data to update weighting factors for determining whether the first entity 410 has communicated an adequate amount of information to exceed the predetermined threshold of the communication plan. In an embodiment that utilizes weighting factors to evaluate different attributes in the data, efficacy evaluation mechanism 404 may update the weighting factors based on the result of the second task 412. An improvement in the execution of the second task 412 enables efficacy evaluation mechanism 404 to increase its accuracy of determinations related to transfer tasks.

In an embodiment of the present invention, in order to improve program code utilized by efficacy evaluation mechanism 404, including but not limited to certain weighting factors, as depicted in Table 3 above, applied to the differences between the data that may be referred to as a communication plan and the actual data communicated by the first entity 410, efficacy evaluation mechanism 404 may first identify certain inputs. These inputs include, but are not limited to, weighting factors utilized in the aforementioned determinations, data related to historical determinations, information related to tasks subsequent to transfer tasks, data related to past determinations and improvement of the weighting utilized in these historical determinations, or the like. Data related to historical determinations obtained by the efficacy evaluation mechanism 404 may include, but is not limited to, the values of the data identified as related to a transfer task, information related to the data actually communicated during a transfer task, determinations by efficacy evaluation mechanism 404 and the reasoning behind the determinations, or the like. Information related to tasks subsequent to transfer tasks obtained by efficacy evaluation mechanism 404 may include, but is not limited to, the anticipated starting date of tasks, the anticipated date of completion of tasks, the planned hours to complete the tasks, or the like.

In an embodiment of the present invention, based on an indication that the second task 412 is complete, efficacy evaluation mechanism 404 determines whether the first entity 410 has communicated an adequate amount of information to exceed the predetermined threshold of the communication plan to the second entity 414 by performing a correlation analysis between the data identified (the planned result) and the data communicated (the actual result) for data associated with each attribute of a transfer task. In this analysis, the value is 0 if the actual results are as planned. Efficacy evaluation mechanism 404 also analyzes any deviation in hours utilized to complete tasks, contrasting the number of hours utilized to complete a given task with the hours anticipated to complete the task. Efficacy evaluation mechanism 404 assigns the value is 0 if the actual results are as planned. Efficacy evaluation mechanism 404 updates weighting factors so that the weighting factors for any item having a higher correlation becomes larger than the value prior to being updated.

In another embodiment, if efficacy evaluation mechanism 404 identifies no difference between a planned period to complete the task subsequent to a transfer task and the actual period utilized to complete this subsequent task, efficacy evaluation mechanism 404 may lower the sensitivity of the weighting factors that are utilized in determining whether the pre-defined portion of data has been transferred during the transfer task. Efficacy evaluation mechanism 404 may lower the sensitivity regardless of whether efficacy evaluation mechanism 404 generated an alert based on the portion of the pre-defined data communicated.

Conversely, in another embodiment, if efficacy evaluation mechanism 404 identifies a difference between a planned period to complete the task subsequent to a transfer task and the actual period utilized to complete this subsequent task, efficacy evaluation mechanism 404 may raise the sensitivity of the weighting factors that are utilized in determining whether the pre-defined portion of data has been transferred during the transfer task. Efficacy evaluation mechanism 404 may lower the sensitivity regardless of whether an alert was generated based on the adequate amount of information communicated and whether it exceed the predetermined threshold of the communication plan.

In yet another embodiment, after efficacy evaluation mechanism 404 has performed a correlation analysis between the planned and actual periods utilized by the second entity 414 to complete the second task 412 (e.g., the task subsequent to the third task 418, efficacy evaluation mechanism 404 may calculate an update range on the basis of this analysis and the past determination history and the history of improvement of the determination logic weighting.

Regardless of the adequacy of the data, efficacy evaluation mechanism 404 may also generate an alert upon receiving the indication of completion of the third task 418. That is, efficacy evaluation mechanism 404 generating the alert may include efficacy evaluation mechanism 404 sending the determination via e-mail to one or more predetermined destination(s) that may be registered in advance, for example, to an e-mail address of a project manager. The alert may also include an alert that a user may experience through a graphical user interface. Efficacy evaluation mechanism 404 may also store this determination.

Table 4 illustrates an example of how after the completion of a task subsequent to a transfer task, i.e. the second task 412 after the third task 418 is completed, efficacy evaluation mechanism 404 determines whether, during the first entity 410 completing their portion of the third task 418, an adequate amount of information to exceed the predetermined threshold of the communication plan was provided to the second entity 414. In this, example, the values are equivalent to those in Tables 2-3. However, the weighting factor for data associated with the what and how attributes has been updated. Efficacy evaluation mechanism 404 has assigned a greater weight to the “what” attribute and a lower weight to the “how” attribute. As a result of efficacy evaluation mechanism 404 adjusting the weighting factors, the result differs and efficacy evaluation mechanism 404 does not generate an alert.

TABLE 4

| Data | Value of Data | Value of Data | Weighting | |
|---|---|---|---|---|
| Attribute | Identified | Communicated | Factor | Result |
| Who | 1.0 | 1.0 | 0.2 | 0 |
| What | 2.0 | 1.0 | 0.3 | 0.15 |
| Where | 1.0 | 1.0 | 0.2 | 0 |
| When | 1.0 | 1.0 | 0.2 | 0 |
| How | 3.0 | 1.0 | 0.1 | 0.07 |
| Total | | | | 0.22 |

Returning to the example explained in reference to Table 3, efficacy evaluation mechanism 404 generates an alert if the total is greater than or equal to 0.225, because 0.22 is less than 0.225, efficacy evaluation mechanism 404 does not generate and alert and enables the second entity 414 to commence the second task 412.

As discussed previously, if the first entity 410 does not communicate an adequate amount of information in preparation of the third task 418 to exceed the predetermined threshold of the communication plan, efficacy evaluation mechanism 404 returns the third task 418 to the first entity 410 so that the first entity 410 can provide the adequate amount of information, i.e. rework the third task 418. However, each time a task is returned for rework, additional costs and schedule changes occur. That is, the schedule of a project to which first task 408, second task 412, and third task 418 are related is impacted by each delay in a task being completed both in the amount of time is added to the project by not completing a task on time, time added by having to rework a task, or the like. Furthermore, because of costs to pay the entities performing their assigned task, costs experienced by not completing a project on time, or the like, each delay in a task being completed on time and efficiently, causes additional costs that may not be budgeted for to be incurred. Thus, the illustrative embodiments provide cost and schedule prediction mechanism for predicting a rework rate due to the communication error based on a determination value of a soundness of the communication that caused the error. Utilizing the soundness of communication value, the cost and schedule prediction mechanism calculates additional man-hours (i.e. costs) and schedule changes that are required for subsequent tasks.

In accordance with the illustrative embodiment, each time an entity has to perform rework on a task due to an insufficient amount of information being provided to another entity in a transfer task, additional costs and schedule changes are incurred. One basis for predicting future rework due to an insufficient amount of information being provided to another entity in a transfer task is the results of the determinations performed by efficacy evaluation mechanism 404, such as that in Tables 3 and 4. That is, as one example, when the result in Table 3 was such that the third task 418 had to be returned to the first entity 410 to be reworked, i.e. additional information provided, efficacy evaluation mechanism 404 recorded not only the result but also the amount of time it took for the rework to be performed by the first entity, which may be translated into man-hours and costs. Efficacy evaluation mechanism 404 records such information each time a prediction is performed and, in accordance with the illustrative embodiments, cost and schedule prediction mechanism 406 utilizes this information as “soundness of communication values,” i.e. how sound was the first entity's 410 communication in the third task 418 (the transfer task) to the second entity 414 in predicting a rework rate, i.e. costs and schedule changes for subsequent tasks.

That is, each time an entity has to rework a task, cost and schedule prediction mechanism 406 predicts a rework rate and a feedback of analysis. Cost and schedule prediction mechanism 406 predicts the rework rate value using the following formula:

$$Rework Rate Value ( \% ) = \frac{Predicted Value - Planned Value}{Planned Value} \times 100$$

where the Predicted Value is a cost value or a schedule value that is predicted by the cost and schedule prediction mechanism 406 (described in the following paragraphs), and the Planned Value is a cost value or a schedule value that is originally estimated by a project manager. Cost and schedule prediction mechanism 406 stores the determined rework rate as a rework rate value associated with each identified soundness of communication value from which the rework rate value is determined.

That is, cost and schedule prediction mechanism 406 uses a technique such as regression analysis, similarity assessment, or the like, to analyze the soundness of communication of the transfer task and the tendency of the past rework rate due to the soundness of the communication based on the entity having to perform the rework. Utilizing this past project data, cost and schedule prediction mechanism 406 can predict a present rework rate for the transfer task as well as schedule changes for any subsequent tasks. As one example, utilizing the result of Table 4 as a current soundness of communication value, cost and schedule prediction mechanism 406 analyzes a table of soundness of communication values to rework rates such as that shown in Table 5.

TABLE 5

| Soundness of Communication Value | Rework Rate |
|---|---|
| 0.22 | 30% |
| 0.18 | 20% |
| 0.13 | 10% |
| . . . | . . . |

Utilizing Table 5, cost and schedule prediction mechanism 406 is able to predict a present rework rate of 30% using the soundness of communication value 0.22 from Table 4.

However, soundness of communication is not the only way cost and schedule prediction mechanism 406 may be able to predict rework. That is, in another embodiment, cost and schedule prediction mechanism 406 predicts the rework rate based on an allocation for the determination factors of the soundness and the tendency of the past rework rate, such as shown in Table 6.

TABLE 6

| Allocation of Determination Factors | Rework Rate |
|---|---|
| No factor is 0 | 30% |
| Only “What” and “How” are not 0 | 15% |
| Only “Who” and “When” are not 0 | 10% |
| . . . | . . . |

Utilizing Table 6, cost and schedule prediction mechanism 406 is able to predict a present rework rate of 15% because only “What” and “How” are not 0 from Table 4.

In yet another embodiment, cost and schedule prediction mechanism 406 predicts the rework rate based on the work experience of the entity having to rework the transfer task, such as that shown in Table 7.

TABLE 7

| Work Experience of Entity | Rework Rate |
|---|---|
| Less than 1 year | 10% |
| 1 year - less than 5 years | 5% |
| 5 years - less than 10 years | 3% |
| 10 years or more | 0% |

In still another embodiment, cost and schedule prediction mechanism 406 predicts the rework rate based on the a phase in which the transfer task is associated, such as that shown in Table 8.

TABLE 8

| Phase for Transfer Task | Rework Rate |
|---|---|
| External Design Phase | 5% |
| Internal Design Phase | 3% |
| Code/UT | 5% |
| . . . | . . . |

Thus, when the efficacy evaluation mechanism 404 generates the third task 418 and/or when the first entity 410 provides the information requested by efficacy evaluation mechanism 404, based on efficacy evaluation mechanism 404 determination of whether the first entity 410 has communicated an adequate amount of information to the second entity 414, as exemplified in Tables 3 and 4, cost and schedule prediction mechanism 406 determines a rework rate. In addition, cost and schedule prediction mechanism 406 may also provide an analysis of the rework rate based on past project data. That is, utilizing data obtained related to the communications between the first entity 410 and the second entity 414 during previous transfer tasks of the same project or other projects, cost and schedule prediction mechanism 406 focuses on third task 418, (the transfer task) to be transferred from the first entity 410 to the second entity 414 and extracts information from the past project data. For example, cost and schedule prediction mechanism 406 extracts:
In the past projects, the transfer from the first entity 410 to the second entity 414, which is similar to the present case, was performed three times.
In each case, the transfer task transferred from the first entity 410 to the second entity 414 cause a second task (a subsequent task) to be performed as scheduled or with only a slight delay.
From the actual record of the past projects, the second entity 414 had enough background knowledge required for the present project.
   Based on the past data and the statistical processing, cost and schedule prediction mechanism 406 can provide the following suggestion: “It is effective to the transfer task to be transferred from the first entity 410 to the second entity 414 and the subsequent task to be completed with a delay period due to the rework of the transfer task being 15%.

Using the identified rework rate and the feedback analysis, cost and schedule prediction mechanism 406 then notifies a project manager 420 of the rework rate and the feedback analysis and stores the rework rate within a prediction history log. Using the rework rate, cost and schedule prediction mechanism 406 acquires a planned value of any subsequent task, i.e. the second task 412 in the current example, and calculates the additional man-hours that will be incurred due to the rework rate predicted by the third task 418 (the transfer task) and schedule changes for the second task 412. Cost and schedule prediction mechanism 406 provides the additional costs based on additional man-hours and schedule changes to the project manager 420.

As stated above, efficacy evaluation mechanism 404 may redirect the third task 418 back to the first entity 410 if the amount of information provided by the first entity 410 fails to exceed the predetermined threshold of the communication plan. However, if in providing the rework rate, the feedback analysis, the additional costs based on additional man-hours, and the schedule changes to the project manager 420, the project manager 420 may provide an indication of whether to redirect the third task 418 back to the first entity 410 to re-perform the third task 418 or to enables the second entity 414 to commence the second task 412.

If the indication from the project manager 420 is for the first entity 410 to re-perform the third task 418, the operation repeats as described previously. If the indication form the project manager 420 to enables the second entity 414 to commence the second task 412, then once the second entity 414 completes the second task 412, cost and schedule prediction mechanism 406 receives data related to the result of the second task 412, which causes efficacy evaluation mechanism 404 to update weighting factors for determining whether the first entity 410 has communicated an adequate amount of information to exceed the predetermined threshold of the communication plan. By updating the information, cost and schedule prediction mechanism 406 and/or efficacy evaluation mechanism 404 improves any future predicted rework rate based on the soundness of communication value and the actual record of task(s) completion. That is, in one example, cost and schedule prediction mechanism 406 and/or efficacy evaluation mechanism 404 accumulates the soundness of communication value of the third task 418 and the rework rate value of the second task 412 and reanalyzes the tendency whenever the second entity 414 completed the second task 412, which increases the accuracy of the prediction. In another example, cost and schedule prediction mechanism 406 and/or efficacy evaluation mechanism 404 accumulates the work experience of the first entity 410, the second entity 414, and (optionally) the project manager 420 for the third task 418, identifies the rework rate value of the second task 412, and reanalyzes the tendency of the influence of the work experience on the rework rate value whenever the second task 412 is completed, which increases the accuracy of the prediction. In yet another embodiment, cost and schedule prediction mechanism 406 and/or efficacy evaluation mechanism 404 accumulates project data for the third task 418 and the second task 412, which increases the accuracy of any suggestion content to the project manager 420 when utilized in the feedback analysis based on the analysis result. Therefore, efficacy evaluation mechanism 404 and cost and schedule prediction mechanism 406 in conjunction enhance the accuracy of the predicted rework rate to perform a useful prediction of additional costs and schedule changes.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

FIG. 5 depicts a flowchart of the operation performed by an efficacy evaluation mechanism in evaluating the adequacy of an information in a transfer task in accordance with an illustrative embodiment. As the operation begins, the efficacy evaluation mechanism receives an indication from a first entity that a first task assigned to the first entity is complete (step 502). Based on the indication, the efficacy evaluation mechanism generates a third task (step 504). The third task may be understood as a transfer task, in that the third task includes data to be communicated by the first entity to the second entity related to transferring responsibility for the project (or process) from the first entity to the second entity, before the second entity commences the second task. Thus, as part of generating the third task, the efficacy evaluation mechanism identifies data to be communicated from the first entity to the second entity, before the second entity commences with the second task (step 506). The efficacy evaluation mechanism assigns the third task to the first entity to obtain the required information (step 508).

The efficacy evaluation mechanism receives an indication that the first entity has provided information for the third task (step 510) and compares the information provided by the first entity in the third task to the communication plan (step 512). The efficacy evaluation mechanism determines whether the information provided by the first entity is above a predetermined threshold of the communication plan for the second entity to proceed with the second task (step 514). If at step 514 the efficacy evaluation mechanism determines that the first entity did not communicate an adequate amount of information to exceed the predetermined threshold of the communication plan, the efficacy evaluation mechanism generates an alert (step 516). After the efficacy evaluation mechanism generates the alert, the efficacy evaluation mechanism reassigns the third task to the first entity indicating that the first entity has not communicated an adequate amount of information to exceed the predetermined threshold of the communication plan to the second entity (step 518), with the operation returning to step 510 thereafter.

If at step 514 the efficacy evaluation mechanism determines that the first entity did communicate an adequate amount of information to exceed the predetermined threshold of the communication plan, the efficacy evaluation mechanism enables the second entity to commence the second task (step 520). In response to the second entity completing the second task, the efficacy evaluation mechanism receives data related to the result of the second task (step 522) and utilizes the data to update weighting factors for determining whether the first entity has communicated an adequate amount of information to exceed the predetermined threshold of the communication plan (step 524), with the operation ending thereafter.

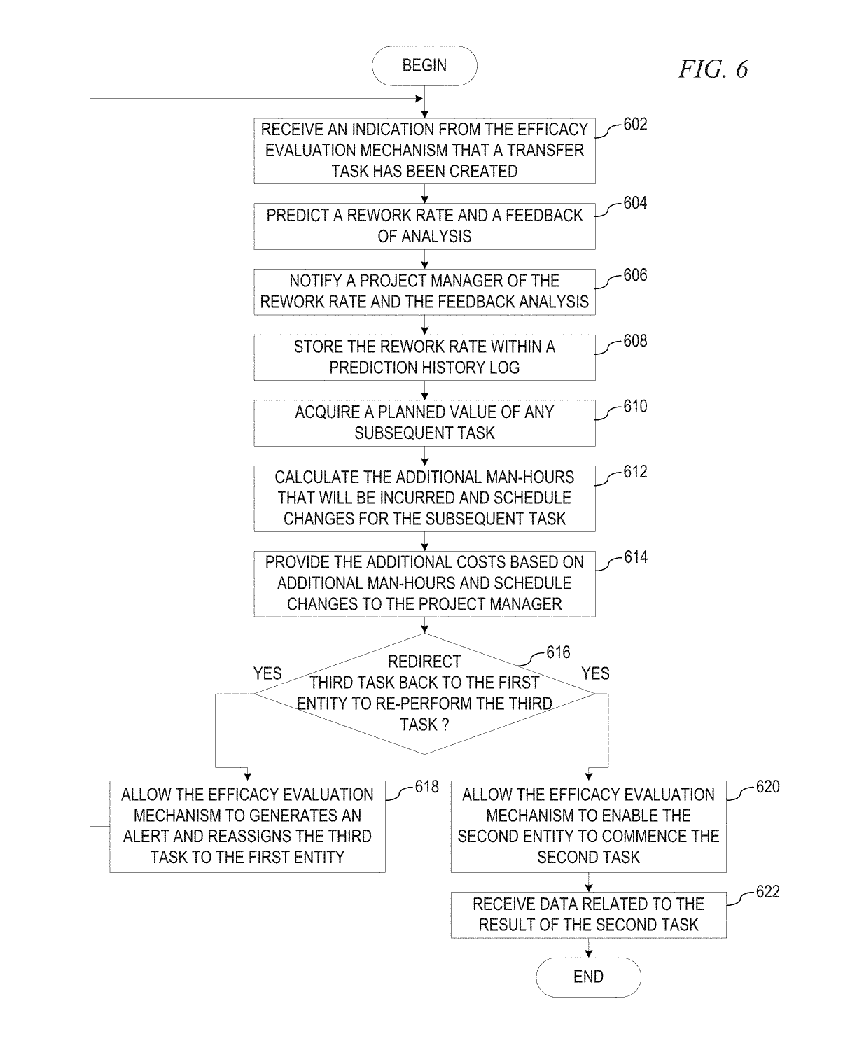

FIG. 6 depicts a flowchart of the operation performed by a cost and schedule prediction mechanism in predicting a rework rate due to the communication error based on a determination value of a soundness of the communication that caused the error in accordance with an illustrative embodiment. As the operation begins, the cost and schedule prediction mechanism receives an indication from the efficacy evaluation mechanism that a transfer task has been created (step 602). Based on the indication the cost and schedule prediction mechanism predicts a rework rate and a feedback of analysis (step 604) using the soundness of communication of the transfer task and the tendency of the past rework rate due to the soundness of the communication based on the entity having to perform the rework. Using the identified rework rate and the feedback analysis, the cost and schedule prediction mechanism notifies a project manager of the rework rate and the feedback analysis (step 606) and stores the rework rate within a prediction history log (step 608). Using the rework rate, the cost and schedule prediction mechanism acquires a planned value of any subsequent task (step 610) and calculates the additional man-hours that will be incurred due to the predicted rework rate of the transfer task and schedule changes for the subsequent task (step 612). The cost and schedule prediction mechanism provides the additional costs based on additional man-hours and schedule changes to the project manager (step 614).

As a preceding step to steps 518 and 520 of FIG. 5, the cost and schedule prediction mechanism determines, based on the information provided, whether the project manager has provided an indication that to redirect the third task back to the first entity to re-perform the third task or to enable the second entity to commence the second task (step 616). If at step 616 the project manager provides an indication to re-perform the third task, then the cost and schedule prediction mechanism allows the efficacy evaluation mechanism to generates an alert and reassigns the third task to the first entity indicating that the first entity has not communicated an adequate amount of information to exceed the predetermined threshold of the communication plan to the second entity (step 618), with the operation returning to step 602 thereafter.

If at step 616 the project manager provides an indication to enables the second entity to commence the second task, the cost and schedule prediction mechanism allows the efficacy evaluation mechanism to enable the second entity to commence the second task (step 620). Once the second entity has completed the subsequent task, the cost and schedule prediction mechanism receives data related to the result of the second task (step 622), which causes the efficacy evaluation mechanism to update weighting factors for determining whether the first entity has communicated an adequate amount of information to exceed the predetermined threshold of the communication plan. By updating the information, the cost and schedule prediction mechanism and/or the efficacy evaluation mechanism improves any future predicted rework rate based on the soundness of communication value and the actual record of task(s) completion. Thereby, the efficacy evaluation mechanism and the cost and schedule prediction mechanism enhance the accuracy of the predicted rework rate to perform a useful prediction of additional costs and schedule changes. The operation ends thereafter.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Thus, the illustrative embodiments provide mechanisms for, by calculating the rework rate due to a communication error, predicting the influence on the subsequent task, resulting in effective means for project management. It is possible to modify the project plan using the prediction of the subsequent task. Further, the prediction of the subsequent task can be quantified, allowing an easy modification of the project plan. By simulating a schedule for the case of returning to the transfer task and a schedule for the case of proceeding to the subsequent task, it is possible to avoid the delay of the project.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a communication bus, such as a system bus, for example. The memory elements can include local memory employed during actual execution of the program code, bulk storage, and cache memories which provide temporary storage of at least some program code in order to reduce the number of times code must be retrieved from bulk storage during execution. The memory may be of various types including, but not limited to, ROM, PROM, EPROM, EEPROM, DRAM, SRAM, Flash memory, solid state memory, and the like.

Input/output or I/O devices (including but not limited to keyboards, displays, pointing devices, etc.) can be coupled to the system either directly or through intervening wired or wireless 1/O interfaces and/or controllers, or the like. I/O devices may take many different forms other than conventional keyboards, displays, pointing devices, and the like, such as for example communication devices coupled through wired or wireless connections including, but not limited to, smart phones, tablet computers, touch screen devices, voice recognition devices, and the like. Any known or later developed I/O device is intended to be within the scope of the illustrative embodiments.

Network adapters may also be coupled to the system to enable the data processing system to become coupled to other data processing systems or remote printers or storage devices through intervening private or public networks. Modems, cable modems and Ethernet cards are just a few of the currently available types of network adapters for wired communications. Wireless communication based network adapters may also be utilized including, but not limited to, 802.11a/b/g/n wireless communication adapters, Bluetooth wireless adapters, and the like. Any known or later developed network adapters are intended to be within the spirit and scope of the present invention.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for predicting a rework rate due to the communication error in a transfer task, the method comprising:
responsive to receiving an indication that the transfer task is being created, the transfer task indicating a transfer of responsibility of a project from a first entity to a second entity, determining a rework rate value and feedback analysis based on a soundness of a communication provided by the first entity in the transfer task;
sending the rework rate value and the feedback analysis to a project manager, wherein, using the rework rate value and the feedback analysis, the project manager provides either an indication to redirect the transfer task back to the first entity to re-perform the transfer task or an indication to enable the second entity to commence with a subsequent task;
responsive to receiving the indication to redirect the transfer task back to the first entity to re-perform the transfer task, sending the transfer task back to the first entity indicating that more information is required for the transfer task; and
responsive to receiving the indication to enable the second entity to commence with the subsequent task, enabling the second entity to commence with the subsequent task.

2. The method of claim 1, wherein the rework rate value is determined by the method comprising:
comparing a current soundness of communication value for the information provided by the first entity to a set of previously determined soundness of communication values; and
responsive to identifying a previously determined soundness of communication value in the set of previously determined soundness of communication values that matches the current soundness of communication value, utilizing a rework rate value associated with the previously determined soundness of communication value as the rework rate value.

3. The method of claim 2, wherein the rework rate value associated with each previously determined soundness of communication value is determined using the following formula:
$$Rework Rate ( \% ) = \frac{Predicted Value - Planned Value}{Planned Value} \times 100$$
where the Predicted Value is a predicted cost value or a predicted schedule value, and the Planned Value is a previously planned cost value or a previously planned schedule value.

4. The method of claim 2, wherein the soundness of communication value is determined based on a difference between information communicated by the first entity and information required in a communication plan and wherein the difference is determined by:
assigning the data provided by the first entity to a pre-defined group of attributes;
assigning a weight to each attribute in the pre-defined group of attributes; and
determining whether the first entity communicated an adequate amount of information by:
for each attribute, multiplying a weighting factor associated with the attribute by a value representing a difference between the information communicated by the first entity and the information required in a communication plan thereby forming a weighted value; and
summing the weighted values to form the soundness of communication value.

5. The method of claim 1, further comprising:
responsive to the second entity completing the subsequent task, receiving data related to a result of the second task; and
updating a set of weighting factors used for determining a soundness communication value based on the result of the second task.

6. The method of claim 1, further comprising:
responsive to the second entity completing the subsequent task, receiving data related to a result of the second task; and
performing one or more of the following:
updating a rework rate value associated with a previously determined soundness of communication value in a set of previously determined soundness of communication values based on the result of the second task thereby improving the accuracy in determining a rework rate of future transfer tasks; or
updating a rework rate value associated with work experience of one or more of the first entity, the second entity, or the project manager based on the result of the second task thereby improving the accuracy in determining the rework rate of future transfer tasks,
wherein updating the rework rate value associated with the previously determined soundness of communication value or updating the rework rate value associated with the work experience of one or more of the first entity, the second entity, or the project manager improves the accuracy of suggestion provided in feedback analysis associated with further transfer tasks.

7. The method of claim 1, further comprising:
using the rework rate value and an acquired planned value of any subsequent task, calculating additional man-hours that will be incurred due to rework of the transfer task and schedule changes for the subsequent task;
sending additional costs based on the additional man-hours and the schedule changes to the project manager for use in determining whether to redirect the transfer task back to the first entity to re-perform the transfer task or to enable the second entity to commence with the subsequent task.

8. A computer program product comprising a computer readable storage medium having a computer readable program for predicting a rework rate due to a communication error in a transfer task stored therein, wherein the computer readable program, when executed on a computing device, causes the computing device to:
responsive to receiving an indication that the transfer task is being created, the transfer task indicating a transfer of responsibility of a project from a first entity to a second entity, determine a rework rate value and feedback analysis based on a soundness of a communication provided by the first entity in the transfer task;
send the rework rate value and the feedback analysis to a project manager, wherein, using the rework rate value and the feedback analysis, the project manager provides either an indication to redirect the transfer task back to the first entity to re-perform the transfer task or an indication to enable the second entity to commence with a subsequent task;
responsive to receiving the indication to redirect the transfer task back to the first entity to re-perform the transfer task, send the transfer task back to the first entity indicating that more information is required for the transfer task; and
responsive to receiving the indication to enable the second entity to commence with the subsequent task, enable the second entity to commence with the subsequent task.

9. The computer program product of claim 8, wherein the rework rate value is determined by the computer readable program further causing the computing device to:
compare a current soundness of communication value for the information provided by the first entity to a set of previously determined soundness of communication values; and
responsive to identifying a previously determined soundness of communication value in the set of previously determined soundness of communication values that matches the current soundness of communication value, utilize a rework rate value associated with the previously determined soundness of communication value as the rework rate value.

10. The computer program product of claim 9, wherein the rework rate value associated with each previously determined soundness of communication value is determined using the following formula:
$$Rework Rate ( \% ) = \frac{Predicted Value - Planned Value}{Planned Value} \times 100$$
where the Predicted Value is a predicted cost value or a predicted schedule value, and the Planned Value is a previously planned cost value or a previously planned schedule value.

11. The computer program product of claim 9, wherein the soundness of communication value is determined based on a difference between information communicated by the first entity and information required in a communication plan and wherein the difference is determined the computer readable program further causing the computing device to:
assign the data provided by the first entity to a pre-defined group of attributes;
assign a weight to each attribute in the pre-defined group of attributes; and
determine whether the first entity communicated an adequate amount of information by:
for each attribute, multiply a weighting factor associated with the attribute by a value representing a difference between the information communicated by the first entity and the information required in a communication plan thereby forming a weighted value; and
sum the weighted values to form the soundness of communication value.

12. The computer program product of claim 8, wherein the computer readable program further causes the computing device to:
responsive to the second entity completing the subsequent task, receive data related to a result of the second task; and
update a set of weighting factors used for determining a soundness communication value based on the result of the second task.

13. The computer program product of claim 8, wherein the computer readable program further causes the computing device to:
responsive to the second entity completing the subsequent task, receive data related to a result of the second task; and
perform one or more of the following:
update a rework rate value associated with a previously determined soundness of communication value in a set of previously determined soundness of communication values based on the result of the second task thereby improving the accuracy in determining a rework rate of future transfer tasks; or
update a rework rate value associated with work experience of one or more of the first entity, the second entity, or the project manager based on the result of the second task thereby improving the accuracy in determining the rework rate of future transfer tasks,
wherein updating the rework rate value associated with the previously determined soundness of communication value or updating the rework rate value associated with the work experience of one or more of the first entity, the second entity, or the project manager improves the accuracy of suggestion provided in feedback analysis associated with further transfer tasks.

14. The computer program product of claim 8, wherein the computer readable program further causes the computing device to:
using the rework rate value and an acquired planned value of any subsequent task, calculate additional man-hours that will be incurred due to rework of the transfer task and schedule changes for the subsequent task;
send additional costs based on the additional man-hours and the schedule changes to the project manager for use in determining whether to redirect the transfer task back to the first entity to re-perform the transfer task or to enable the second entity to commence with the subsequent task.

15. An apparatus for predicting a rework rate due to a communication error in a transfer task comprising:
a processor; and
a memory coupled to the processor, wherein the memory comprises instructions which, when executed by the processor, cause the processor to:
responsive to receiving an indication that the transfer task is being created, the transfer task indicating a transfer of responsibility of a project from a first entity to a second entity, determine a rework rate value and feedback analysis based on a soundness of a communication provided by the first entity in the transfer task;
send the rework rate value and the feedback analysis to a project manager, wherein, using the rework rate value and the feedback analysis, the project manager provides either an indication to redirect the transfer task back to the first entity to re-perform the transfer task or an indication to enable the second entity to commence with a subsequent task;
responsive to receiving the indication to redirect the transfer task back to the first entity to re-perform the transfer task, send the transfer task back to the first entity indicating that more information is required for the transfer task; and
responsive to receiving the indication to enable the second entity to commence with the subsequent task, enable the second entity to commence with the subsequent task.

16. The apparatus of claim 15, wherein the rework rate value is determined by the instructions further causing the processor to:
compare a current soundness of communication value for the information provided by the first entity to a set of previously determined soundness of communication values; and
responsive to identifying a previously determined soundness of communication value in the set of previously determined soundness of communication values that matches the current soundness of communication value, utilize a rework rate value associated with the previously determined soundness of communication value as the rework rate value.

17. The apparatus of claim 16, wherein the rework rate value associated with each previously determined soundness of communication value is determined using the following formula:
$$Rework Rate ( \% ) = \frac{Predicted Value - Planned Value}{Planned Value} \times 100$$
where the Predicted Value is a predicted cost value or a predicted schedule value, and the Planned Value is a previously planned cost value or a previously planned schedule value.

18. The apparatus of claim 16, wherein the soundness of communication value is determined based on a difference between information communicated by the first entity and information required in a communication plan and wherein the difference is determined the instructions further causing the processor to:
assign the data provided by the first entity to a pre-defined group of attributes;
assign a weight to each attribute in the pre-defined group of attributes; and
determine whether the first entity communicated an adequate amount of information by:
for each attribute, multiply a weighting factor associated with the attribute by a value representing a difference between the information communicated by the first entity and the information required in a communication plan thereby forming a weighted value; and
sum the weighted values to form the soundness of communication value.

19. The apparatus of claim 15, wherein the instructions further cause the processor to:
responsive to the second entity completing the subsequent task, receive data related to a result of the second task; and
update a set of weighting factors used for determining a soundness communication value based on the result of the second task.

20. The apparatus of claim 15, wherein the instructions further cause the processor to:
responsive to the second entity completing the subsequent task, receive data related to a result of the second task; and
perform one or more of the following:
update a rework rate value associated with a previously determined soundness of communication value in a set of previously determined soundness of communication values based on the result of the second task thereby improving the accuracy in determining a rework rate of future transfer tasks; or
update a rework rate value associated with work experience of one or more of the first entity, the second entity, or the project manager based on the result of the second task thereby improving the accuracy in determining the rework rate of future transfer tasks,
wherein updating the rework rate value associated with the previously determined soundness of communication value or updating the rework rate value associated with the work experience of one or more of the first entity, the second entity, or the project manager improves the accuracy of suggestion provided in feedback analysis associated with further transfer tasks.
